(19) United States
(12) Patent Application Publication
(10) Pub. No.: US 2013/0082009 A1
(43) Pub. Date: Apr. 4, 2013

(54) PHOTOCATALYST COMPOSITION OF MATTER

(71) Applicants: William O'Keefe, Guelph (CA); Michael Sasges, Victoria (CA)

(72) Inventors: William O'Keefe, Guelph (CA); Michael Sasges, Victoria (CA)

(73) Assignee: Trojan Technologies, London, ON (CA)

(21) Appl. No.: 13/582,354

(22) PCT Filed: Feb. 22, 2011
(86) PCT No.: PCT/CA2011/000193

§ 371 Date: Dec. 12, 2012

Related U.S. Application Data
(60) Provisional application No. 61/282,570, filed on Mar. 2, 2010.

(51) Int. Cl. C02F 1/70; B01J 27/22; C02F 1/32; B01J 27/24; B01J 23/847; B01J 35/00; B01J 27/04

(52) U.S. Cl. CPC C02F 1/70; B01J 35/004; B01J 27/22; B01J 27/04; B01J 27/24; B01J 23/8476; C02F 1/32
USPC 210/748.14; 502/100; 502/300; 502/177; 502/216; 502/200; 502/344

(57) ABSTRACT

There is described a photocatalyst composition of matter comprising a support material. A surface of the support material configured to comprise: (i) a first catalytic material for catalyzing the conversion of H₂O to H₂ and O₂, and (ii) a second catalytic material catalyzing reaction of hydrogen with a target compound. The photocatalyst composition of matter can be used to treat an aqueous fluid containing a target chemical compound, for example, by a process comprising the steps of: (i) contacting the aqueous fluid with the above-mentioned photocatalyst composition of matter; (ii) contacting the aqueous fluid with radiation during Step (i); (iii) catalyzing the conversion of water in the aqueous fluid to H₂ and O₂ with the first catalytic material; and (iv) catalyzing reaction of the target chemical compound in the aqueous fluid with hydrogen from Step (iii) in the presence of the second catalytic material to produce a modified chemical compound.

### CROSS-REFERENCE TO RELATED APPLICATION

The present application claims the benefit under 35 U.S.C. §119(e) of provisional patent application Ser. No. 61/282,570, filed Mar. 2, 2010, the contents of which are hereby incorporated by reference.

### BACKGROUND OF THE INVENTION

1. Field of the Invention

In one of its aspects, the present invention relates to a photocatalyst composition of matter. In another of its aspects, the present invention relates to a process for treating an aqueous fluid containing a target compound

2. Description of the Prior Art

Many of the most toxic compounds found in water are unsaturated organic compounds, including nitrosamines such as N-nitrosodimethylamine (NDMA). NDMA, for example, is an extremely toxic compound that is known to cause cancer in humans and is also known to be a mutagen. There is no acceptable exposure limit of NDMA for humans. The California Department of Health Services has established Notification Levels of 0.01 micrograms per litre for a number of nitrosamines (NDEA, NDPA and NDMA). This is an early step in the process of developing a drinking water standard which would define upper limits for these chemicals in drinking water and recharge waters for aquifers.

Current best practice for contaminant treatment is to employ direct photolysis via the application of UV energy either alone or in combination with an oxidant such as hydrogen peroxide to generate OH radicals to break down the contaminant to other, less toxic compounds. This method is costly requiring high UV doses (because most of the incident photons do not interact with NDMA molecules) and therefore large amounts of equipment and energy. The high frequency energy used in these processes results in the rapid solarisation of the quartz sleeve, thus significantly reducing the efficiency of UV transmission and adversely affecting reactor performance. The process is also inefficient, since most of the oxidant is not consumed in the process, and most of the OH radicals do not interact with the contaminant but are either consumed by other compounds in the water or recombine to produce hydrogen peroxide.

Atrazine and dioxane are particularly resistant to photolytic degradation and require an alternative means to effectively achieve its remediation.

In contrast, the photocatalytic approaches investigated for the treatment of environmental contaminants using UV photoreactors have not specifically investigated the catalytic reduction of the organic contaminant but rather have employed, for example, the use of a TiO₂ catalyst for the purpose of generating hydroxyl radicals to facilitate the destruction of the contaminant. The hydroxyl radical approach is characterized by poor catalytic performance with low quantum yields. It has been established in the art that the photocatalytic activity of TiO₂ is inhibited by the presence of water for many reactions and TiO₂ is therefore not suitable for many condensed aqueous phase applications. The hydroxyl radical route is also characterized by non-selective chemistry with high energy products and is subject to hydroxyl radical scavenging and the co-production of undesirable products.

It is also known to use hydrogenation catalysts in order to chemically reduce contaminant species in aqueous solution. However, these processes require the addition of exogenous hydrogen to enable the reaction which results in significant associated operating costs. This hydrogen must be added from other reagents, or by the addition of gaseous hydrogen, usually under elevated pressure and/or temperature in order to achieve sufficient concentrations of hydrogen in the aqueous solution since hydrogen is only sparingly soluble in most solvents including water. The low solubility of hydrogen in water invariably leads to mass transfer limitations in catalytic reactors that adversely affect the catalytic performance.

The art is in need of an efficient approach to effectively remediate contaminant and/or toxic compounds such as nitrosamines (NDEA, NDPA and NDMA) and trichloroethylene (TCE). It would be particularly advantageous if such an approach could be readily incorporated into existing fluid treatment systems without the need to build grass-roots systems.

### SUMMARY OF THE INVENTION

It is an object of the present invention to obviate or mitigate at least one of the above-mentioned disadvantages of the prior art.

It is another object of the present invention to provide a novel photocatalyst composition of matter.

Accordingly, in one of its aspects, the present invention provides a photocatalyst composition of matter comprising a support material, a surface of the support material configured to comprise: (i) a first catalytic material for catalyzing the conversion of H₂O to H₂ and O₂, and (ii) a second catalytic material catalyzing reaction of hydrogen with a target compound.

In another of its aspects, the present invention provides a process for treating an aqueous fluid containing a target chemical compound, the process comprising the steps of:

(i) contacting the aqueous fluid with the present photocatalyst composition of matter;

(ii) contacting the aqueous fluid with radiation during Step (i);

(iii) catalyzing the conversion of water in the aqueous fluid to H₂ and O₂ with the first catalytic material; and

(iv) catalyzing reaction of the target chemical compound in the aqueous fluid with hydrogen from Step (iii) in the presence of the second catalytic material to produce a modified chemical compound.

In general, the present invention provides a novel means to reform target compounds (e.g., remediate toxic environmental contaminants) found in aqueous liquids such as water. Preferably, the present invention provides a means to reform contaminant and/or toxic compounds to modified chemical compounds that are non-toxic or substantially less toxic than the original contaminant and/or toxic compound via photocatalytic assisted reactions between hydrogen and the target compound (e.g., via catalytic hydrogenation, via catalytic hydrogenolysis, via catalytic hydrodechorination and the like) utilizing either a multifunctional catalyst or a mixture of catalysts in combination with a photoreactor, preferably a UV photoreactor. This process can be regarded generally as photocatalytic reduction. The present inventor has discovered that photocatalytic reduction provides a reaction pathway to stable products that is more energy efficient and thermodynamically favourable than conventional photolysis, UV plus peroxide and TiO₂ catalyzed photocatalytic degradation, and will generally lead to higher chemical conversion of the contaminant and/or toxic compounds due to the favourable thermodynamics and facile kinetics.

Using the present photocatalyst composition of matter, NDMA and other toxic compounds can be chemically transformed to relatively stable and/or safe products that are less toxic. Unsaturated toxins can be hydrogenated to form saturated compounds that are far less toxic or in some cases non-toxic. Other toxic compounds such as the carcinogen trichloroethylene (TCE) can also be transformed to stable and less toxic compounds by catalytic reduction for which hydrogen is a reactant. For example, TCE can be remediated by reductive dechlorination.

While known organic contaminants such as NDMA and TCE are well known examples of target chemical compounds that can be converted to relatively stable and/or safe compounds using the present photocatalyst composition of matter, it is possible to treat other target chemical compounds. For example, if the target chemical compound contains one or points of unsaturation (e.g., unsaturation of the phenyl moiety commonly present in many chemical compounds), the second catalytic material in the present photocatalyst composition of matter may be selected to effect hydrogenation. If the target chemical compound contains one or C—C, C—N and/or C—O bonds, the second catalytic material in the present photocatalyst composition of matter may be selected to effect hydrogenolysis.

Thus, the present photocatalyst material may be used to treat a wide variety of target chemical compounds such as pharmaceuticals and endocrine disruptors.

Pharmaceuticals

Norethynodrel:

An active ingredient in oral contraceptives. As can be seen, this compound has points of unsaturation on the molecule including a carbon-carbon triple bond, a carbon-carbon double bond and a carbonyl (C═O) group.

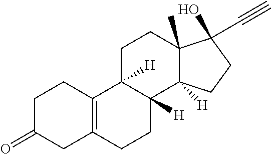

Cortisol (Hydrocortisone):

A steroid that alters protein metabolism. Also used to treat inflammation and allergies. The molecule has two carbon-carbon double bonds and a carbonyl group that may be subjected to hydrogenation or to hydrogenolysis, respectively. The carbonyl groups and hydroxyl groups (OH) make the molecule partially miscible in water.

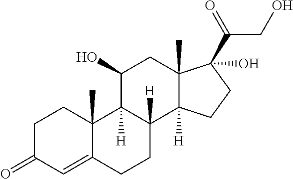

Aspirin (Acetyl Salicylic Acid):

The two carbonyl groups and hydroxyl group make the compound sparingly soluble in water. Multiple points of unsaturation on the molecule include a benzene ring (susceptible to hydrogenation) and two carbonyl groups (susceptible to hydrogenolysis).

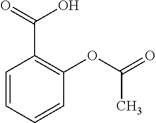

Acetominophen:

This molecule contains a benzene ring, carbonyl group, hydroxyl group and an amine group. The C—N linkages and C—O linkages may undergo hydrogenolysis.

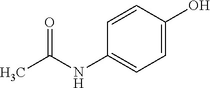

Lipitor (Atorvastatin Calcium):

Lipitor is a commonly used medication to moderate the production of cholesterol. The molecule contains a multiplicity of unsaturated cyclic compounds as well as unsaturation at multiple carbonyl groups and olefin (C═C) groups. The molecule also contains amine (NH) groups and multiple hydroxyl groups. Multiple C—N, C—C and C—O linkages. These various groups are susceptible to hydrogenation or hydrogenolysis, as the case may be, as discussed above.

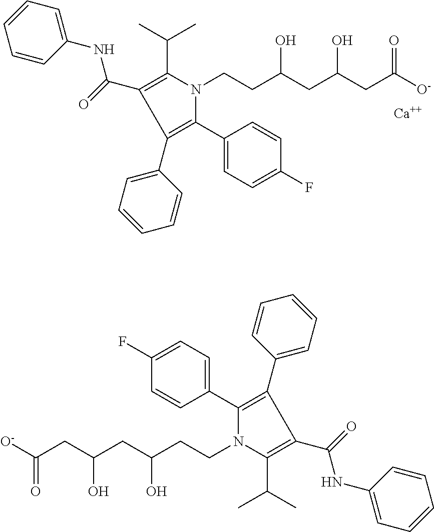 [SMILES: CC(C)c1c(C(=O)Nc2ccccc2)c(-c2ccccc2)c(-c2ccc(F)cc2)n1CCC(O)CC(O)CC(=O)[O-] ; [Ca+2] ; CC(C)c1c(C(=O)Nc2ccccc2)c(-c2ccccc2)c(-c2ccc(F)cc2)n1CCC(O)CC(O)CC(=O)[O-]]

Prozac:

This drug is an antidepressant used to affect neurotransmitters in the human brain. It contains two phenyl groups that could be hydrogenated. It also contains an amine group and an ether linkage are available for reaction.

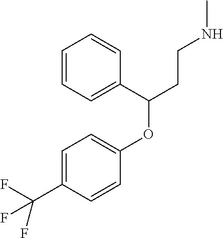 [SMILES: CNCCC(Oc1ccc(C(F)(F)F)cc1)c1ccccc1]

Endocrine Disruptors

Bisphenol A:

This chemical compound originates as a by-product in plastic products. The hydroxyl groups induce some solubility in water. Two phenyl rings available for hydrogenation.

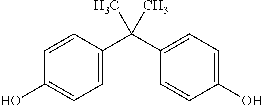 [SMILES: CC(C)(c1ccc(O)cc1)c1ccc(O)cc1]

Polybromide Diphenyl Ether (Diphenyl Ether Structure Shown Below):

This chemical compound is used in flame retardants and electronics materials. Polybromide diphenyl ether has 2 or more bromine atoms added over rings but some unsaturated groups left. The unsaturated groups and C—O linkages may be susceptible to hydrogenolysis and hydrogenation respectively.

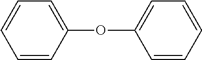 [SMILES: c1ccc(Oc2ccccc2)cc1]

DDT:

This is a well known pesticide. The molecule contains two phenyl rings susceptible to catalytic hydrogenation and chloride leaving groups, possibly amenable to hydrogenolysis.

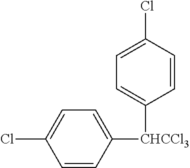

Phthalates:

Phthalates are a family of chemicals used in plasticizers for plastics. For the general structure of phthalates, replace the OH with OR and OR′ where R and R′ are hydrocarbon chains with 4 to 15 carbons.

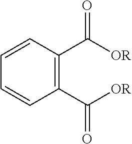

(each R is independently a C₄ to C₁₅ aliphatic group)

While the foregoing discussion is focussed on pharmaceuticals and endocrine disruptors often found in water, it should be understood that the target chemical compounds that may be converted using the present photocatalyst composition of matter are not necessarily so restricted and the discussion is provided for illustrative purposes only.

In a preferred embodiment, the catalytic reduction of unsaturated organic compounds using hydrogen as a reactant in a water solvent has been investigated as a means of water treatment using conventional catalytic reactor technologies. In these applications, catalytic reduction may be carried out in the aqueous phase at low temperature and pressure using a heterogeneous catalyst in a fixed bed reactor. Since the concerted addition of molecular hydrogen to a pi bond of an unsaturated compound is symmetry forbidden from quantum mechanics, a hydrogenation catalyst is present for the catalytic hydrogenation or hydrogenolysis reaction to occur.

During use of the present photocatalyst composition of matter, molecular hydrogen is believed to be generated in situ within a photoreactor (producing radiation such as UV radiation, visible and the like), for example using an highly efficient photocatalyst for water splitting (e.g., oxynitride catalysts or NiO/NaTaO₃:La) that have quantum efficiencies routinely in excess of 50% for photocatalytic water splitting in the UV range. The photocatalyst will efficiently generate hydrogen from photocatalytic splitting of water making use of the UV energy available in the reactor. In some embodiments, the photocatalyst will also serve as a support material onto which a hydrogenation catalyst will be dispersed. Hydrogen and the organic contaminant may adsorb on the hydrogenation catalyst resulting in the rapid chemical conversion of the organic toxin to stable and less toxic compounds.

As previously stated, the state of the art of photocatalysis for environmental contaminant treatment involves the use of TiO₂ to facilitate a hydroxyl radical route to the photolytic degradation of the organic toxin. The chemistry of the hydroxyl radical route is non-selective and undesirable byproducts of the reaction may be produced. The state of the art catalysts are characterized by low quantum efficiencies and water is known to adversely affect the photocatalytic performance of TiO₂. Use of the present photocatalyst composition of matter obviates or mitigates these problems by providing an entirely different reaction mechanism utilizing a multifunctional catalyst for water splitting that, in a preferred embodiment, has been demonstrated to perform well in aqueous environment. Unlike the prior art free radical approach described above, the reductive transformation can be done selectively and thus obviates or mitigates the formation of undesirable by-products.

In a preferred embodiment, the present photocatalyst composition of matter may be regarded as a combination of a catalyst for water splitting and a conventional hydrogenation catalyst resulting in a multifunctional photocatalyst that can effect the reductive transformation of an unsaturated organic contaminant from hydrogen that is efficiently generated in situ from the water splitting reaction utilizing the available energy. The themodynamics of the photocatalytic reduction route are favourable and will proceed spontaneously in the presence of an appropriate catalyst resulting in the production of stable products, unlike the free radical route.

The in situ generation of hydrogen via photocatalysis has distinct advantages over the conventional catalytic hydrogenation route using conventional reactors. Specifically, the hydrogen is produced at the active site and thus obviates or mitigates the transport steps required in the conventional catalytic reactor to bring hydrogen to the active site, which involves: (1) absorption of hydrogen into the solvent, (2) convective mass transfer of the hydrogen to the boundary layer, (iii) diffusion across the boundary layer, and (iv) intraparticle diffusion (and interparticle diffusion in the case of fixed beds). These mass transfer resistances can be significant in catalytic reactors, particularly in solvents for which hydrogen is only sparingly soluble and can have a substantial adverse effect on the reactor performance. In contrast, by generating hydrogen in situ, using the present photocatalyst composition of matter, the concentration of hydrogen can be optimized at the catalyst surface. The catalyst is preferably configured such that the surface concentration of hydrogen at the active sites of the catalyst will be in stoichiometric excess of the target compound (e.g., contaminant and/or toxic compound) to be reformed, facilitating its rapid conversion to stable and/or less toxic products.

### BRIEF DESCRIPTION OF THE DRAWINGS

Embodiments of the present invention will be described with reference to the accompanying drawings, wherein like reference numerals denote like parts, and in which:

FIG. 1 illustrates a schematic representation of a multifunctional catalyst to facilitate catalytic hydrogenation of an unsaturated compound;

FIG. 2 illustrates a schematic representation of photocatalytic reduction of NDMA using the present photocatalyst composition of matter;

FIG. 3 illustrates predicted NDMA and Hydrogen concentrations (ppm) versus time in a 400 mL batch photoreactor in the presence of UV energy and 4 grams of Catalyst A and 0.2 grams of Catalyst B pursuant to Example 2; and

FIG. 4 illustrates predicted TCE and Hydrogen concentrations (ppm) versus time in a 400 mL batch photoreactor in the presence of UV energy and 4 grams of Catalyst A and 4 grams of Catalyst C pursuant to Example 3.

### DETAILED DESCRIPTION OF THE PREFERRED EMBODIMENTS

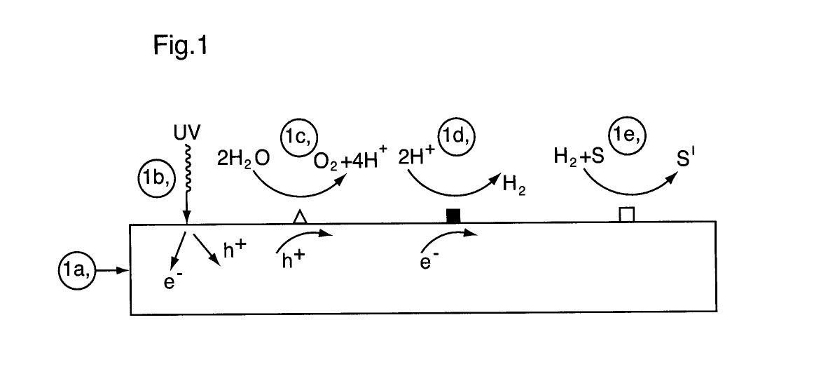

While not wishing to be bound by any particular theory or mode of action, with reference to FIG. 1, there is illustrated schematic representation of a multifunctional catalyst to facilitate the catalytic hydrogenation of an unsaturated compound. The photocatalyst has been modified to integrate a hydrogenation catalyst into its architecture resulting in a multifunctional photocatalyst capable of facilitating hydrogen production from the photocatalytic splitting of water and reductive transformation of an undesirable organic compound to more desirable products.

FIG. 1a): The photocatalyst may consist of a semiconductor such as (Ga₁₋ₓZnₓ)(N₁₋ₓO) (alternatives are discussed below) whose active sites denoted by hollow triangles for oxidation sites and filled boxes for reduction sites have been configured for optimal performance for photocatalytic water splitting in the UV range.

FIG. 1b): A photon of UVC energy is absorbed by the photocatalyst generating an electron-hole pair. The electron in the conduction band is denoted (e⁻) and the “hole” in the valence band is denoted (h⁺).

FIG. 1c): Water adsorbs on the photocatalyst at an oxidation site on the photocatalyst and interacts with a hole causing the water molecule to split resulting in oxygen evolution and the generation of protons.

FIG. 1d): Protons adsorb at a reduction site on the photocatalyst and interact with an electron resulting in hydrogen evolution.

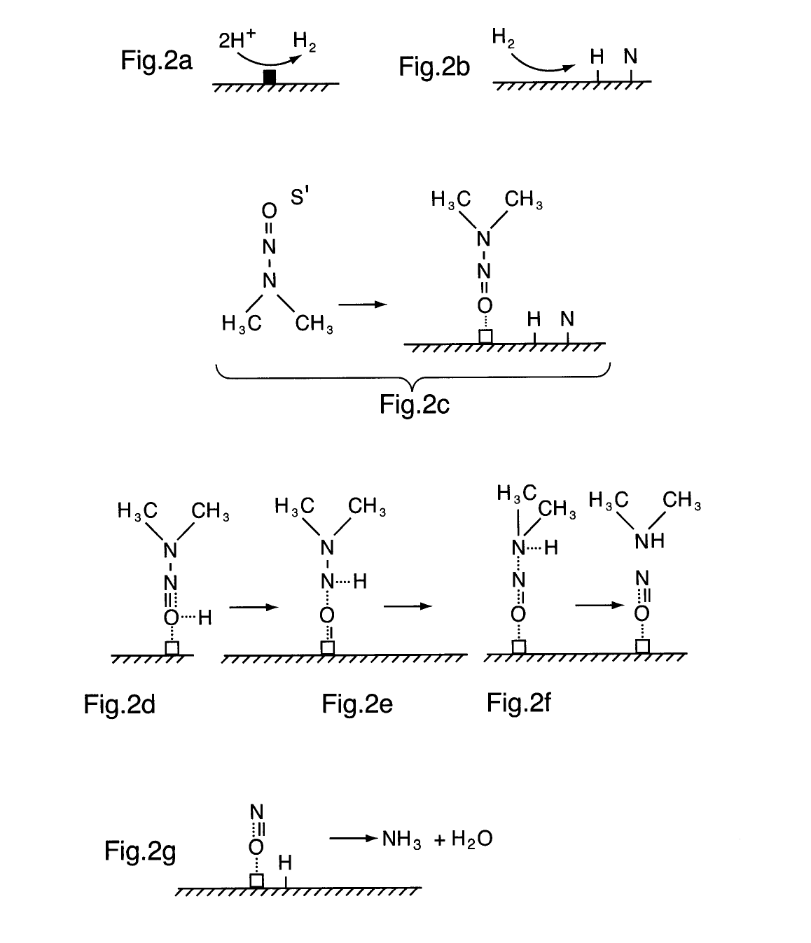

FIG. 1e): Hydrogen and the organic substrate (S) adsorb on an active site for hydrogenation (or hydrogenolysis) resulting in the catalytic reduction of the substrate to a more desirable product or products (S′). Omitted for clarity in FIG. 1e), hydrogen adsorbs dissociatively on the hydrogenation catalyst producing adsorbed atomic hydrogen as illustrated in FIG. 2b) discussed below.

Again, while not wishing to be bound by any particular theory or mode of action, with reference to FIG. 2, there is illustrated in schematic form a mechanism of the photocatalytic reduction of NDMA using the present photocatalyst composition of matter.

FIG. 2a): Molecular hydrogen is generated in situ at the surface of the photocatalyst on a reduction site.

FIG. 2b): Molecular hydrogen adsorbs dissociatively on an active site for hydrogenation (i.e., on the surface of the hydrogenation catalyst) resulting in the generation of adsorbed hydrogen atoms.

FIG. 2c): NDMA has electron density about the oxygen atom and will interact with electron-withdrawing active sites of the photocatalyst. NDMA will adsorb onto the catalyst via co-ordination with the oxygen atom. Although the illustration suggests an η₁ coordination, it is for illustrative purposes and other adsorption modes or other possible reaction mechanisms are contemplated.

FIGS. 2d), 2e) and 2f): Atomic hydrogen is added to the adsorbed NDMA. The adsorbed intermediate species re-arranges by the migration of the hydrogen atom. Dimethyl amine (DMA) is liberated leaving adsorbed nitric oxide.

FIG. 2g): Nitric oxide is further reduced in a similar manner to produce water and ammonia.

The overall reaction for the photocatalytic reductive transformation of NDMA is given in equation A. The reaction is thermodynamically favourable and kinetically facile.

$$3 {H}_{2} + {C}_{2} {N}_{2} {H}_{6} O {}^{UV , catalyst} {C}_{2} {NH}_{7} + {H}_{2} O + {NH}_{3} \\ Δ {H}_{r}^{°} = - 306 \frac{kJ}{mol} \qquad ( A )$$

Thus, in a preferred embodiment, the present invention relates to a process for the reductive transformation of organic compounds to stable and more desirable compounds utilizing hydrogen that is produced in situ within the UV photoreactor using a photocatalyst that is active for the splitting of water in the presence of UV energy. In a more preferred embodiment, the catalytic phase responsible for the catalytic reduction of the organic compound is dispersed directly onto the photocatalyst, which serves as a support phase for the hydrogenation catalyst. The combination of these catalytic solid phases results in a multifunctional photocatalyst that carries out the following transformation where S denotes the organic contaminant to be transformed, S′ denotes the more desirable organic product and n is a stoichiometric coefficient:

H₂O→H₂+½O₂ (B)

S+nH₂→S′ (C)

The multifunctional photocatalyst may be put into practice, for example, either by circulating through the photoreactor as a slurry and recovered from the effluent and recycled, or slurried within a fluidized bed in a photoreactor or it may be immobilized within the photoreactor.

Preferably, the water splitting catalyst serves as a support for a dispersed phase of catalytic material responsible for the catalytic reduction of the unsaturated contaminant. Alternatively, the hydrogenation catalyst and photocatalyst may be separate materials that are in reasonable proximity in the reactor to enable the hydrogen that is generated from the photocatalyst to facilitate the reductive transformation. Alternatively, the water splitting catalyst and the hydrogenation catalyst may be co-dispersed onto or otherwise combined with a third phase which serves as a support material.

Preferably, the photocatalyst is comprised of a semiconductor material with a band gap ranging from 2 to 4 eV, which is in the energy range of UVC, such that it may facilitate the splitting of water to generate hydrogen and oxygen. In a more preferred embodiment, the semiconductor consists of an oxynitride such as (Ga₁₋ₓZnₓ)(Znₓ₋₁O) that can facilitate photocatalytic water splitting with high quantum efficiency (i.e. >50%) in the UV range. The hydrogen evolution sites of the photocatalyst may be comprised of a co-catalyst material such as NiO, RuO₂, Rh—Cr mixed oxide, Rh/Cr₂O₃ to facilitate hydrogen evolution and optimize the performance of photocatalytic water splitting. In a preferred embodiment, the present photocatalyst composition of matter can be configured such that the rate of hydrogen production is sufficient to ensure that the concentration of adsorbed hydrogen on the hydrogenation catalyst is in stoichiometric excess of the organic contaminant to be destroyed by reductive transformation. In a even more preferred embodiment, the semiconductor consists of a 0.2 wt % nickel oxide dispersed on a NaTaO₃ and doped with 2 mol % La (i.e. NiO/NaTaO₃:La).

If the first catalytic material is a hydrogenation catalyst, it is preferred to generally consist of metal crystallites, for example a Group VIII metal such as Ni, Pt, Pd etc. or copper or alloys or composites thereof containing these metals. The hydrogenation catalyst may be doped or otherwise modified to instill high activity and moisture tolerance such as a NiB catalyst—see, for example, Frierdich et al. (2009), Appl. Catal. B., 90, 175. Similarly, the crystallite size of the dispersed hydrogenation catalyst may be selected based on whether the reaction is structure sensitive or structure insensitive. The precise formulation and treatment will be dependent on the target unsaturated organic compound to be reformed.

Thus, an aspect of the present invention relates to a photocatalyst composition of matter comprising a support material, a surface of the support material configured to comprise: (i) a first catalytic material for catalyzing the conversion of H₂O to H₂ and O₂, and (ii) a second catalytic material catalyzing reaction of hydrogen with a target compound.

Preferred embodiments of the photocatalyst composition of matter may include any one or a combination of any two or more of any of the following features:
the second catalytic material catalyzes reaction of hydrogen with a target organic compound;
the second catalytic material catalyses hydrogenation of the target compound;
the second catalytic material catalyses hydrogenolysis of the target compound;
the second catalytic material catalyses hydrodechlorination of the target compound;
the support material and the first catalytic material are non-integral;
the support material and the first catalytic material are integral;
the support material comprises a particulate support material;
the support material comprises a semiconductor material;
the support material comprises a transition metal oxide having a band gap in the range of from about 1.23 to about 6.7 eV;
the support material comprises a transition metal oxide having a band gap in the range of from about 1.23 to about 5.0 eV;
the support material comprises a transition metal oxide having a band gap in the range of from about 1.5 to about 4.0 eV;
the support material comprises a non-photocatalalytically active material;
the support material comprises carbon;
the support material comprises activated carbon;
the support material comprises high surface area activated carbon;
the support material comprises an organic polymer material;
the support material comprises an ion exchange resin;
the support material comprises a photocatalytically active non-oxide material.
the photocatalytically active non-oxide material comprises a zeolite;
the photocatalytically active non-oxide material comprises an aluminosilicate compound;
the support material comprises a carbide compound;
the support material comprises SiC;
the support material comprises a sulfide compound;
the support material comprises MoS₂;
the support material comprises a chalcogenide compound;
the support material comprises CdSe;
the support material comprises a nitride compound;
the support material comprises β—Ge₃N₄;
the support material comprises a metal oxide;
the support material comprises a transition metal oxide;
the transition metal oxide comprises a transition metal with a d¹⁰ or d⁰ electronic configuration (d orbitals either completely filled or completely empty) or a transition that can attain a d¹⁰ or d⁰ electronic configuration;
the transition metal is selected from the group consisting of V, Mo, Zn, Ti, Nb, Zr, Ta, W, Ga, Ge, In, Sn and Sb;
the transition metal is selected from the group consisting of Ti, Zr, Nb, Ta, W, Ga, Ge, In, Sn and Sb;
the support material comprises TiO₂;
the support material and the first catalytic material, in combination, are selected from the group consisting of Pt/TiO₂, SrTiO₃, K₄Nb₆O₁₇, Rb₄Nb₆O₁₇, Nb₂O₅, ZrO₂, Fe₂O₃, NaTaO₃, RbNbWO₆ and RbTaWO₆ or a derivatives thereof produced by with a co-catalyst material or a promotor material;
the co-catalyst material or promoter material is selected from the group consisting of Ba, Na, La, K, Gd, Y, N and S;
the support material and the first catalytic material, in combination, comprises NiO/NaTaO₃:La;
the support material and the first catalytic material, in combination, comprises an oxynitride material
the support material and the first catalytic material, in combination, comprises an oxynitride material comprising one or more of Ca, La, Ti, Nb and Ta;
the particulate support material and the first catalytic material, in combination, comprises a compound selected from the group consisting of MTaO₂N (wherein M is Ca, La, Sr or Ba), LaTiO₂N, CaNbO₂N, Ca_{.25}La_{.75}TiO_{2.25}N_{.75}, (Ga₁₋ₓZnₓ)(N₁₋ₓO) wherein x is selected from the range of 0 to about 1.0, TaON, Ta₃N₅ and mixtures thereof;
the particulate support material and the first catalytic material, in combination, comprises a compound selected from the group consisting of MTaO₂N (wherein M is Ca, La, Sr or Ba), LaTiO₂N, CaNbO₂N, Ca_{.25}La_{.75}TiO_{2.25}N_{.75}, (Ga₁₋ₓZnₓ)(N₁₋ₓO) wherein x is selected from the range of about 0.05 to about 0.20, TaON, Ta₃N₅ and mixtures thereof;
the particulate support material and the first catalytic material, in combination, comprises an oxysulfide material;
the oxysulfide material has the formula Ln₂Ti₂S₂O₅ where Ln is a lanthanoid;
the lanthanoid is selected from the group consisting of Pr, Nd, Sm, Gd, Tb, Dy, Ho and Er;
the lanthanoid is Sm;
first catalytic material further comprises a first co-catalyst material;
the first co-catalyst material comprises a metal select from Groups 8, 9, 10 or 11 of the periodic material, an oxide thereof or an alloy thereof with at least one other metal;
the first co-catalyst material comprises a compound selected from the group consisting of NiO, RuO₂, Rh—Cr mixed oxide, Rh/Cr₂O₃ and mixtures thereof;
the second catalytic material catalyzes at least two of: (i) reaction of hydrogen with a target organic compound, (ii) hydrogenation of the target compound, and (iii) hydrogenolysis of the target compound;
the second catalytic material simultaneously catalyzes at least two of: (i) reaction of hydrogen with a target organic compound, (ii) hydrogenation of the target compound, and (iii) hydrogenolysis of the target compound;
the second catalytic material comprises a transition metal, an alloy thereof or a nitride thereof;
the second catalytic material comprises a transition metal oxide that is activated to a catalytic form upon exposure to a reducing agent;
the second catalytic material comprises a transition metal oxide that is activated to a catalytic form upon exposure to hydrogen;
the second catalytic material comprises a transition metal oxide that is activated to a catalytic form upon exposure to hydrogen from conversion of H₂O to H₂ and O₂ by the first catalytic material;
the transition metal comprises a member selected from the group consisting of a noble metal from Groups 8, 9, 10 or 11 of the Periodic Table; and/or
the transition metal comprises a member selected from the group consisting of Pd, Pt, Ni and Cu.

Another aspect of the present invention relates to a process for treating an aqueous fluid containing a target chemical compound, the process comprising the steps of: (i) contacting the aqueous fluid with the above-mentioned photocatalyst composition of matter; (ii) contacting the aqueous fluid with radiation during Step (i); (iii) catalyzing the conversion of water in the aqueous fluid to H₂ and O₂ with the first catalytic material; and (iv) catalyzing reaction of the target chemical compound in the aqueous fluid with hydrogen from Step (iii) in the presence of the second catalytic material to produce a modified chemical compound. Preferred embodiments of the process may include any one or a combination of any two or more of any of the following features:
Step (ii) comprises contacting the aqueous fluid with ultraviolet radiation during Step (i);
Step (ii) comprises contacting the aqueous fluid with visible radiation during Step (i);
the photocatalyst composition of matter is immobilized with respect to a flow of the aqueous fluid;
the photocatalyst composition of matter is immobilized on a porous structure;
the photocatalyst composition of matter comprises a porous structure;
the photocatalyst composition of matter is immobilized on a surface of a fluid treatment zone through which a flow of the aqueous fluid passes;
the photocatalyst composition is immobilized as a thin film (e.g., to provide a high surface area mesoporous material to immobilze the catalyst within the reactor) or a coating on the surface of the fluid treatment system;
the surface comprises a wall of the fluid treatment zone;
the surface comprises a structure secured to the fluid treatment zone;
the structure comprises a mixing device;
the structure comprises a baffle;
Step (i) comprises formation of a slurry comprising the aqueous fluid and the photocatalyst composition of matter;
the process comprises, after Step (iv), separating the photocatalyst composition of matter from the aqueous fluid and repeating Steps (i), (ii), (iii) and (iv);
Steps (i) and (ii) are conducted in a fluidized bed; and/or
the process comprises, after Step (iv), recovering the photocatalyst composition of matter from a fluidized bed and repeating Steps (i), (ii), (iii) and (iv).

Preferred embodiments of the present invention are illustrated with reference to the following examples which are non-limiting in nature and should not be used to construe or otherwise limit the invention.

### Example 1

### Preparation of a Multifunctional Ni/NiO/NaTaO₃:La

In this Example, there is described preparation of a multifunctional catalyst and testing of that multifunctional catalyst in a photoreactor for the catalytic reduction of N-Nitrosodimethylamine (NDMA). Some basic background on the preparative method the multifunctional catalyst may be obtained from H. Kato, H. Asakura and A. Kudo (2003), J. Am. Chem. Soc., 125, 3082 [Kato et al.] which describes a La doped NiO/NaTaO₃ catalyst reported to have the highest activity for hydrogen production from water splitting in the UV range (@ 270 nm)—see A. Kudo and Y. Miseki (2009), Chem. Soc. Rev., 28, 253.

First the semiconductive photocatalyst, which serves as a support material for the dispersed catalytic hydrogenation sites, is prepared. The follow procedure is used:
1. La₂O₃, Na₂CO₃ and Ta₂O₅, all of high purity (>99%) are mixed together in the ratio Na:La:Ta (1-X):X:1 where X=0.02.
2. Sodium is added in an amount to provide 5 mol % excess sodium.
3. The mixture is placed in a crucible and calcined in air at 1170 K in a muffle furnace for 1 hour.
4. The mixture is recovered and ground with a mortar and pestle.
5. The mixture is placed in the crucible and returned to the muffle furnace where it is calcined in air at 1420 K for 10 hours.
6. After completion of the high temperature solid state reaction, the material is a lanthanum (La) doped NaTaO₃ powder—i.e., NaTaO₃:La. The powder is placed in a beaker of deionised water in the ratio of 7 mL of water per gram of NaTaO₃. The slurry is agitated by a magnetic stirrer at room temperature for approximately 10 minutes.
7. The NaTaO₃ powder is then recovered from the water by vacuum filtration.
8. The recovered powder is then dried at 320 K for 2 to 12 hours in air.
9. A NiO co-catalyst phase is dispersed onto the NaTaO₃:La by aqueous impregnation. As a basis for this example, 1 gram of NaTaO₃:La powder is to be impregnated. An aqueous impregnation solution is prepared by dissolving 7.8 mg of Ni(NO₃)₂.6H₂O in approximately 5 mL of deionised water. The impregnation solution is added to the powder contained in a crucible. Ideally the volume of water is into which the Ni(NO₃)₂.6H₂O is dissolved is selected in a manner that brings the powder to incipient wetness upon contact. (i.e., just enough liquid to completely fill the pore volume).
10. The solution is allowed to contact the powder for 2 hours, periodically stirring the solution with a glass rod.
11. After the solution has contacted the powder for 2 hours, the crucible is placed in an oven at a temperature ranging from 60 to 100° C. The crucible is maintained at elevated temperature in the oven until all of the water has evaporated.
12. The crucible is recovered from the oven and the powder is calcined in air at 540 K for 1 hour.

Steps 1-12 result in preparation of a NiO/NaTaO₃:La catalyst. The optimal formulation for hydrogen evolution is believed to be 2 mol % La and 0.2% NiO. The specific surface area would be about 3.2 m²/g and its activity for hydrogen production under UV irradiation by a 400 W high pressure mercury lamp in a 390 mL cell described by Kato et al. (cited above) would be 19.8 mmol/hr*g_{cat}.

Next, the NaTaO₃:La semiconductor photocatalyst prepared in steps 1-12 is functionalized with 2.0 wt % Ni. The following procedure is used.
13. 70 mg of NiCl₂.6H₂O is dissolved in approximately 5 mL of deionised water. The volume of water is selected to be the minimum amount necessary to fill the pore volume of the NaTaO₃:La semiconductor support.
14.1 g of the NaTaO₃:La semiconductor photocatalyst is placed in a crucible.
15. The NiCl₂.6H₂O solution is added to the crucible containing the semiconductor photocatalyst and allowed to contact the solid for 2 hours, stirring periodically with a glass rod.
16. The crucible is placed in an oven at 60° C. to 105° C. until the liquid has evaporated.
17. The specimen is transferred to a Schlenk tube or vacuum flask with a seal cap.
18. A borohydride solution is prepared by dissolving 1.52 g NaBH₄ into 40 mL of deionised water. The solution is placed in a vessel and sealed.
19. The Schlenk tube containing the catalyst and the vessel containing the borohydride solution are transferred to a glove box and an inert environment is established.
20. The borohydride solution from Step 18 is transferred to the Schlenk tube containing the catalyst. Periodically, the solution is vigorously agitated by shaking with the Schlenk tube sealed. During periods of non-agitation, the tube valve is open to the inert atmosphere to allow evolved hydrogen to escape the flask.
21. After approximately 10 minutes of contact time, or when the hydrogen evolution has ceased, the liquid is separated from the catalyst by vacuum separation using a Schlenk system with a cold trap. The catalyst is retained in the Schlenk tube under vacuum for 24 hours to dry. The low temperature reduction with low contact time is expected to effect the reduction of the Ni from the NiCl₂.6H₂O solution, but not the NiO phase that was calcined at elevated temperature.
22. The catalyst is returned to the glove box (inert atmosphere) without exposure to air for storage until needed. Similarly, when needed, the catalyst is transferred to the reactor without exposure to air. Some of the equipment and/or materials specifically mentioned in the above procedure may be modified. For example, the catalyst may be functionalized with other transition metals (Pt, Pd, Rh, Ru and the like) by conventional impregnation techniques or other standard scientific procedures.

### Example 2

### Catalytic Reduction of NDMA from the Reaction of Hydrogen Generated In Situ from the Photocatalytic Water Splitting Using a Mixture of 2 Catalysts (Raney and Ni and NiO/NaTaO₃:La Catalysts) Slurried in a Batch Photoreactor

In this example, 4 grams of a water splitting photocatalyst (Catalyst A) is prepared as described in Example 1, Steps 1-12 corresponding to the synthesis of a NiO/NiO/NaTaO3:La with a NiO content of 0.2 wt % and an La content of 2 mol %. A second catalyst (Catalyst B) is used to facilitate catalytic hydrogenolysis of NDMA in the presence of hydrogen. Catalyst B is a commercially available Raney nickel catalyst (87% Ni, 8% Al) with a specific surface area of 100 m²/g and pore volume of 0.11 cm³/g as described in A. J. Frierdich, C. E. Joseph and T. J. Strathman (2009), Appl. Catal. B., 90, 175.[Frierdich et al.].

A small photoreactor is charged with 400 mL of water. 4 grams of catalyst A and 0.2 g of Catalyst B are charged to the reactor and slurried. The fluid is vigorously agitated using a mechanical impeller operated at approximately 1000 RPM to ensure the reaction is under kinetic control. The slurry is irradiated with ultraviolet (UV) energy using lamps immersed into the reactor in a manner to give the same irradiation and the same water splitting kinetics and pseudo zero-order rate constant to produce molecular hydrogen as observed by Kato et al. (cited above). Specifically the production of hydrogen from the photocatalytic water splitting at atmospheric pressure is observed to be pseudo zero-order with a pseudo zero-order rate constant of 19.8 mmol/(hr*g_{cat}). Similarly, it is believed that the NDMA is decomposed by reaction with the hydrogen generated in situ to produce dimethyl amine (DMA), ammonia and water following the kinetics reported by Frierdich et al (cited above) for the commercial benchmark Raney nickel catalyst whereby the reaction is first order with respect to NDMA and pseudo zero-order with respect to hydrogen. The pseudo first-order rate constant for the decomposition of NDMA over Raney nickel catalyst reported by Frierdich et al. (cited above) is 77.9 L/(g_{Ni}*hr) at 25° C. and atmospheric pressure (i.e., it is believed the water is saturated with hydrogen).

In this example, 2 catalyst materials are used. In the preferred embodiment, a multifunctional catalyst would be used, which would result in a substantial kinetic enhancement due to the in situ production of hydrogen that would result in a higher concentration of hydrogen at the active sites for NDMA reduction. There is a potential advantage of in situ hydrogen generation or synergistic effect due to the multifunctional catalyst of the present invention.

The first of two kinetic rate expressions is:

r₁=k₁*W└mol/hr┘

where r₁ is the rate of hydrogen production via water splitting over the semiconductor catalyst, W is the mass of catalyst charged to the reactor and k₁ is the rate constant (19.8×10⁻³ mol/hr*g_{cat}) reported by Kato et al. (cited above) for a NiO/NaTaO₃:La catalyst with 1 mol % La and 0.2 wt % NiO. The rate of hydrogen production is independent of the volume of water.

The second of the two kinetic rate expressions is:

r₂=k₂*W_{Ni}C₂└mol/hr┘

where r₂ is the rate of destruction of NDMA, C₂ is the concentration of NDMA (mol/L), W_{Ni} is the mass of Raney nickel catalyst and k₂ is the pseudo first order rate constant for the decomposition of NDMA by catalytic reduction over Raney Ni (77.9 L/g_{Ni}*hr) reported by Frierdich et al. (cited above).

For this example, the kinetics of the degradation of NDMA from photolysis from direct exposure to UV radiation is neglected. Thus, the results of this example are conservative in that the conversion of NDMA will be more rapid than predicted due to the contribution of UV photolysis.

Using the design equation for an ideal batch reactor, and only considering hydrogen and NDMA (ignoring by-products), there results the following system of 2 first order Ordinary Differential Equations (ODE)

$$\begin{matrix}\frac{d {N}_{1}}{d t} = + {r}_{1} + {r}_{2} = + {k}_{1} W - {k}_{2} {W}_{Ni} ( \frac{{N}_{2}}{V} ) & ( 1 ) \\ \frac{d {N}_{2}}{d t} = {r}_{2} = - {k}_{2} {W}_{Ni} ( \frac{{N}_{2}}{V} ) & ( 2 )\end{matrix}$$

where N₁ is the number of moles of hydrogen in the reactor, N₂ is the number of moles of NDMA in the reactor, and V is the volume (400 mL) of the reactant. The concentrations of hydrogen and NDMA at any time are therefore N₁/V and N₂/V respectively. In the case of hydrogen, whether hydrogen exists as a gas or dissolved in the liquid is neglected. It is believed that the same hydrogenation kinetics as observed by Frierdich et al. would be observed, whereby the reaction rate is independent of the hydrogen concentration. Note that for the illustrative Examples 2 and 3, the hydrogen concentration (N₁/V) is expressed without regard to whether the hydrogen is dissolved in the liquid or in the gaseous phase. However, the results sufficiently demonstrate that for the conditions investigated, hydrogen is produced at a greater rate than that of the contaminant destruction and that the solvent is saturated rapidly, which is will yield the conditions of the reported hydrogenation kinetics.

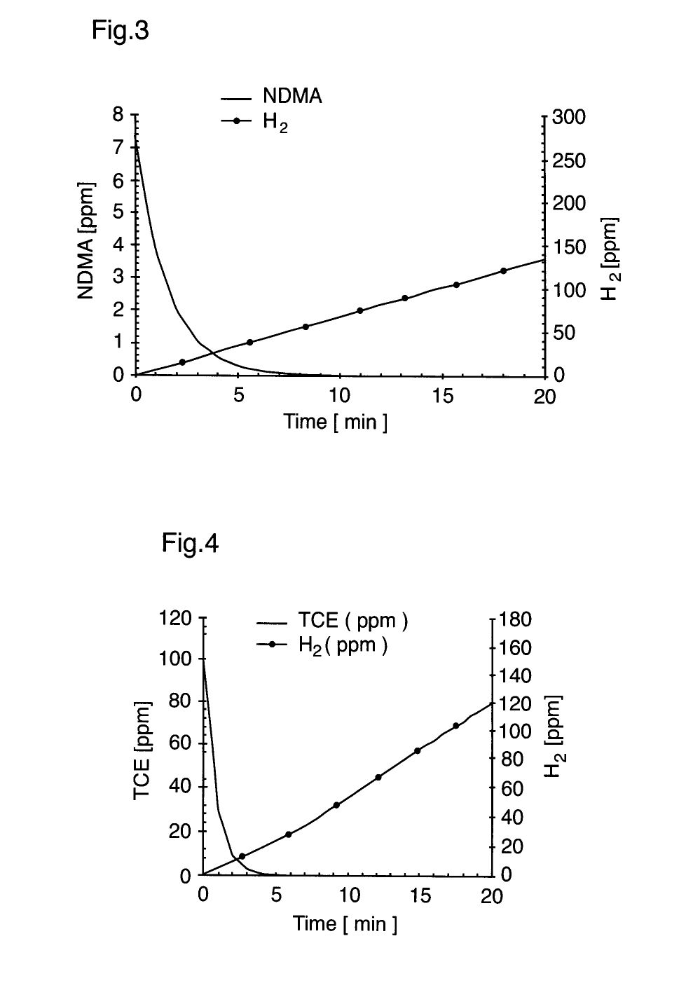

The reactor is initially charged with 400 mL of deionised water and is charged with 4×10⁻⁵ mol of NDMA to give an initial concentration of 100 μmol/L (i.e., 7.4 ppm). With reference to Formulae (1) and (2) above, the initial conditions are N₁=0 and N₂=4×10⁻⁵ mol. As the reaction is enabled by initiating UV irradiation, NDMA is catalytically reduced to produce dimethyl amine, ammonia and water. The predicted concentration profiles are illustrated in FIG. 3. The simulated results were obtained by numerically solving the two ODE subject to the two initial conditions.

The results set out in FIG. 3 and Table I illustrate a 3 log reduction in NDMA after about 10 minutes. The results also demonstrate that the water is saturated with hydrogen within an initial period of 14 seconds (cf. the solubility of hydrogen in water at 25° C. and atmospheric pressure is about 1.6 ppm).

TABLE I
Data for FIG. 3

| time (min) | H₂ (ppm) | NDMA (ppm) |
|---|---|---|
| 0 | 0 | 7.41E+00 |
| 1 | 6.783026 | 3.87E+00 |
| 2 | 13.56631 | 2.02E+00 |
| 3 | 20.35031 | 1.06E+00 |
| 4 | 27.13549 | 5.52E−01 |
| 5 | 33.92269 | 2.88E−01 |
| 6 | 40.71331 | 1.51E−01 |
| 7 | 47.50958 | 7.87E−02 |
| 8 | 54.31533 | 4.12E−02 |
| 9 | 61.1374 | 2.15E−02 |
| 10 | 67.98588 | 1.12E−02 |
| 11 | 74.87669 | 5.87E−03 |
| 12 | 81.72275 | 3.07E−03 |
| 13 | 88.14892 | 1.60E−03 |
| 14 | 94.80166 | 8.37E−04 |
| 15 | 101.454 | 4.38E−04 |
| 16 | 108.1061 | 2.29E−04 |
| 17 | 114.7583 | 1.19E−04 |
| 18 | 121.4104 | 6.24E−05 |
| 19 | 128.0626 | 3.26E−05 |
| 20 | 134.7147 | 1.70E−05 |

### Example 3

### Hydrodechlorination of Trichloroethylene (TCE) from the Reaction of Hydrogen Generated In Situ from the Photocatalytic Splitting of Water Using a Slurry of Two Catalysts

A similar experiment to that described above in Example 2 is conducted using the same batch photoreactor initially charged with 400 mL of water and 4 grams of Catalyst A. In addition, 4 grams of a commercially available catalyst (Catalyst C) consisting of 1 wt % Pd/Al₂O₃ with a specific surface area of 177 m²/g described by M. O. Knutt, J. B. Hughes and M. S. Wong (2005) Environ. Sci. Technol., 39, 1346 [Knutt et al.].

The water in the photoreactor is initially spiked with trichloroethylene (TCE) a known carcinogen and contaminant found in groundwater. The initial TCE concentration is 100 ppm. The catalytic hydrodechlorination of TCE is carried out in the reactor from the reaction of hydrogen produced in situ from the photocatalytic splitting of water. It is believed that the catalyst will be irradiated by UV such that the photocatalytic water splitting kinetics observed by Kato et al. (cited above) will occur. Similarly, the hydrodechlorination of TCE will proceed in accordance with the first order kinetics reported by Knutt et al. (cited above) for the commercially available Pd/Al₂O₃ catalyst. Specifically the pseudo first-order rate constant for TCE hydrodechlorination at atmospheric pressure and 22 to 25° C., k₂=12.2 L/(min*g_{Pd}) is used in Equation (2) from Example 2. It is believed that the solvent will rapidly saturate with hydrogen.

The predicted concentration profiles are illustrated in FIG. 4. The simulated results ere obtained by numerically solving the two ODE subject to the two initial conditions.

TABLE II
Data for FIG. 4

| time (min) | H₂ (ppm) | TCE (ppm) |
|---|---|---|
| 0 | 0 | 1.00E+02 |
| 1 | 4.779633 | 2.95E+01 |
| 2 | 9.560092 | 8.72E+00 |
| 3 | 14.34305 | 2.57E+00 |
| 4 | 19.1324 | 7.60E−01 |
| 5 | 23.93868 | 2.24E−01 |
| 6 | 28.7874 | 6.62E−02 |
| 7 | 33.72865 | 1.96E−02 |
| 8 | 40.2086 | 5.77E−03 |
| 9 | 46.86008 | 1.70E−03 |
| 10 | 53.51156 | 5.03E−04 |
| 11 | 60.16304 | 1.49E−04 |
| 12 | 66.81452 | 4.39E−05 |
| 13 | 73.466 | 1.30E−05 |
| 14 | 80.11768 | 3.83E−06 |
| 15 | 86.76956 | 1.13E−06 |
| 16 | 93.42165 | 3.34E−07 |
| 17 | 100.0735 | 9.88E−08 |
| 18 | 106.7254 | 2.99E−08 |
| 19 | 113.3775 | 8.99E−09 |
| 20 | 120.029 | 3.04E−09 |

The results in FIG. 4 and Table II suggest a 3 log reduction of TCE will be observed in about 3 minutes in the reactor under these conditions. In this reaction, hydrogen is being consumed more rapidly from the reaction with the organic substrate. However, the results suggest that for this initial concentration of TCE, the solvent is saturated with hydrogen within the first 20 seconds.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A photocatalyst composition of matter comprising a support material, a surface of the support material configured to comprise: (i) a first catalytic material for catalyzing the conversion of H₂O to H₂ and O₂, and (ii) a second catalytic material catalyzing reaction of hydrogen with a target compound.

2. The photocatalyst composition of matter defined in claim 1, wherein the second catalytic material catalyzes reaction of hydrogen with a target organic compound.

3-7. (canceled)

8. The photocatalyst composition of matter defined in claim 1, wherein the support material comprises a particulate support material.

9. (canceled)

10. The photocatalyst composition of matter defined in claim 1, wherein the support material comprises a transition metal oxide having a band gap in the range of from about 1.23 to about 6.7 eV.

11-12. (canceled)

13. The photocatalyst composition of matter defined in claim 1, wherein the support material comprises a non-photocatalytically active material.

14-18. (canceled)

19. The photocatalyst composition of matter defined in claim 1, wherein the support material comprises a photocatalytically active non-oxide material.

20-21. (canceled)

22. The photocatalyst composition of matter defined in claim 1, wherein the support material comprises a carbide compound.

23. (canceled)

24. The photocatalyst composition of matter defined in claim 1, wherein the support material comprises a sulfide compound.

25. (canceled)

26. The photocatalyst composition of matter defined in claim 1, wherein the support material comprises a chalcogenide compound.

27. (canceled)

28. The photocatalyst composition of matter defined in claim 1, wherein the support material comprises a nitride compound.

29. The photocatalyst composition of matter defined in claim 1, wherein the support material comprises β—Ge₃N₄.

30. The photocatalyst composition of matter defined in claim 1, wherein the support material comprises a metal oxide.

31-35. (canceled)

36. The photocatalyst composition of matter defined in claim 1, wherein the support material and the first catalytic material, in combination, are selected from the group consisting of Pt/TiO₂, SrTiO₃, K₄Nb₆O₁₇, Rb₄Nb₆O₁₇, Nb₂O₅, ZrO₂, Fe₂O₃, NaTaO₃, RbNbWO₆ and RbTaWO₆ or a derivatives thereof produced by with a co-catalyst material or a promotor material.

37-39. (canceled)

40. The photocatalyst composition of matter defined in claim 1, wherein the support material and the first catalytic material, in combination, comprises an oxynitride material comprising one or more of Ca, La, Ti, Nb and Ta.

41. The photocatalyst composition of matter defined in claim 1, wherein the particulate support material and the first catalytic material, in combination, comprises a compound selected from the group consisting of MTaO₂N (wherein M is Ca, La, Sr or Ba), LaTiO₂N, CaNbO₂N, Ca_{.25}La_{.75}TiO_{2.25}N_{.75}, (Ga₁₋ₓZnₓ)(N₁₋ₓO) wherein x is selected from the range of 0 to about 1.0, TaON, Ta₃N₅ and mixtures thereof.

42-49. (canceled)

50. The photocatalyst composition of matter defined in claim 1, wherein the second catalytic material catalyzes at least two of: (i) reaction of hydrogen with a target organic compound, (ii) hydrogenation of the target compound, and (iii) hydrogenolysis of the target compound.

51-52. (canceled)

53. The photocatalyst composition of matter defined in claim 1, wherein the second catalytic material comprises a transition metal oxide that is activated to a catalytic form upon exposure to a reducing agent.

54-57. (canceled)

58. A process for treating an aqueous fluid containing a target chemical compound, the process comprising the steps of:
(i) contacting the aqueous fluid with the photocatalyst composition of matter defined in any one of claims 1-57;
(ii) contacting the aqueous fluid with radiation during Step (i);
(iii) catalyzing the conversion of water in the aqueous fluid to H₂ and O₂ with the first catalytic material; and
(iv) catalyzing reaction of the target chemical compound in the aqueous fluid with hydrogen from Step (iii) in the presence of the second catalytic material to produce a modified chemical compound.

59. The process defined in claim 58, wherein Step (ii) comprises contacting the aqueous fluid with ultraviolet radiation during Step (i). The process defined in claim 58, wherein Step (ii) comprises contacting the aqueous fluid with visible radiation during Step (i).

60. (canceled)

61. The process defined in claim 58, wherein the photocatalyst composition of matter is immobilized with respect to a flow of the aqueous fluid.

62. The process defined in claim 58, wherein the photocatalyst composition of matter is immobilized on a surface of a fluid treatment zone through which a flow of the aqueous fluid passes.

63. The process defined in claim 62, wherein the photocatalyst composition is immobilized as a coating or a thin film on the surface of the fluid treatment system.

64. The process defined in claim 62, wherein the surface comprises a wall of the fluid treatment zone.

65. The process defined in claim 62, wherein the surface comprises a structure secured to the fluid treatment zone.

66. The process defined in claim 65, wherein the structure comprises a mixing device.

67. The process defined in claim 65, wherein the structure comprises a baffle.

68. The process defined in claim 58, wherein Step (i) comprises formation of a slurry comprising the aqueous fluid and the photocatalyst composition of matter.

69. The process defined in claim 68, wherein comprising, after Step (iv), separating the photocatalyst composition of matter from the aqueous fluid and repeating Steps (i), (ii), (iii) and (iv).

70. The process defined in claim 58, wherein Steps (i) and (ii) are conducted in a fluidized bed.

71. The process defined in claim 70, comprising, after Step (iv), recovering the photocatalyst composition of matter from fluidized bed and repeating Steps (i), (ii), (iii) and (iv).
